(19) United States
(12) Patent Application Publication
(10) Pub. No.: US 2007/0091015 A1
(43) Pub. Date: Apr. 26, 2007

(54) VEHICLE SEAT ENTERTAINMENT SYSTEM INCORPORATING A DATABUS

(76) Inventors: Patrick M. Lavelle, Sayville, NY (US); James R. Tranchina, Dix Hills, NY (US); George C. Schedivy, Aquebogue, NY (US)

Correspondence Address: F. CHAU & ASSOCIATES, LLC, 130 WOODBURY ROAD, WOODBURY, NY, 11797, US

(21) Appl. No.: 11/556,486

(22) Filed: Nov. 3, 2006

Related U.S. Application Data
(63) Continuation-in-part of application No. 10/912,008, filed on Aug. 5, 2004.
Application No. 10/912,008 is a continuation of application No. 09/698,918, filed on Oct. 27, 2000, now abandoned.
(63) Continuation-in-part of application No. 10/688,611, filed on Oct. 17, 2003.
Application No. 10/688,611 is a continuation-in-part of application No. 10/438,724, filed on May 15, 2003.
(60) Provisional application No. 60/734,353, filed on Nov. 7, 2005.

(51) Int. Cl. G09G 5/00; G09G 3/20

(52) U.S. Cl. 345/55; 345/7

(57) ABSTRACT

A media system for a vehicle comprises a media unit including a display mounted to a seat of the vehicle, a databus line running from the media unit through the seat, and a plurality of media sources electrically connected to the databus line. The databus line may comprise optical fiber.

### CROSS-REFERENCES TO RELATED APPLICATIONS

This application claims the benefit of Provisional Application Ser. No. 60/734,353, filed on Nov. 7, 2005, the contents of which are herein incorporated by reference in their entirety.

This application is a Continuation-In-Part of application Ser. No. 10/912,008, filed on Aug. 5, 2004, which is a Continuation of application Ser. No. 09/698,918, filed on Oct. 27, 2000, the disclosures of which are herein incorporated by reference in their entireties.

This application is a Continuation-In-Part of application Ser. No. 10/688,611, filed on Oct. 17, 2003, which is a Continuation-In-Part of application Ser. No. 10/438,724, filed on May 15, 2003, the disclosures of which are herein incorporated by reference in their entireties.

### BACKGROUND OF THE INVENTION

1. Technical Field

The present disclosure relates to a vehicle seat entertainment system incorporating a databus.

2. Discussion of the Related Art

As society becomes more mobile and therefore spends a greater amount of time traveling and away from home, demand rises for electronic appliances and devices outside the home environment. For example, media units including video screens have been mounted in the headrests of vehicles, facilitating video entertainment on the road. These media units may play video and audio from different medial sources located in different portions of the vehicle.

In conventional systems, many wires are required to effectuate transfer of the video and audio data from more than one media source to media units in multiple vehicle seats, resulting in a complex arrangement of wires running around and through vehicle seats.

Therefore, a need exists for a simplified wiring scheme and mode of data transfer for vehicle seat entertainment systems.

### SUMMARY OF THE INVENTION

A media system for a vehicle, according to an embodiment of the present invention, comprises a media unit including a display mounted to a seat in the vehicle, and a first databus electrically connected to a plurality of media sources, wherein the media unit is electrically connected to the first databus for receiving media from the plurality of media sources.

The plurality of media sources and the first databus may be positioned remote from the seat. The media unit may be electrically connected to the first databus via a second databus. The second databus may run from the media unit through the seat. The first and second databases may comprise optical fiber or copper wire. The second databus may be wireless.

The media unit may further include a first media source and media from the first media source may be provided to the first databus via the second databus. The media system may further comprise another media unit including another display mounted to another seat in the vehicle, wherein the other media unit is electrically connected to the first databus for receiving media from the plurality of media sources and the first media source. The other media unit may be electrically connected to the first databus via a third databus.

The plurality of media sources may be connected to a wireless transmitter via the first databus, wherein the wireless transmitter transmits a broadcast stream of multiplexed audio and video signals from the plurality of media sources, and the media unit receives the broadcast stream.

A media system for a vehicle, according to an embodiment of the present invention, comprises a first media unit including a first display mounted to a first seat of the vehicle, a first databus line running from the first media unit, a second media unit including a second display mounted to a second seat of the vehicle, a second databus line running from the second media unit, and a plurality of media sources electrically connected to a third databus line, wherein the first and second databus lines are electrically connected to the third databus line.

The first and second databus lines may run through the first and second seats, respectively. The first, second and third databus lines may comprise optical fiber or copper wire.

The first media unit may further include a first media source, wherein media from the first media source is provided to the third databus line via the first databus line. The second media unit may receive media from the plurality of media sources and the first media source via the second databus line. The first media unit may receive media from the plurality of media sources via the first databus line.

A media system for a vehicle, according to an embodiment of the present invention, comprises a media unit including a display mounted to a seat of the vehicle, a databus line running from the media unit through the seat, and a plurality of media sources electrically connected to the databus line.

The databus line may comprise copper wire or optical fiber. A transmit circuit may be disposed at a first end of the databus line, and a receive circuit may be disposed at a second end of the databus line, wherein the transmit and receive circuits process at least one of audio or video signals. The transmit and receive circuits may perform an optical communication protocol, including electrical to optical conversions.

### BRIEF DESCRIPTION OF THE DRAWINGS

Exemplary embodiments of the present invention will be described below in more detail, with reference to the accompanying drawings:

FIG. 1A shows a front view of an entertainment system including a media unit coupled to a housing mounted in a headrest, according to an embodiment of the present invention;

FIG. 1B shows a top view of the entertainment system of FIG. 1A with the media unit pivoted outward with respect to the housing, according to an embodiment of the present invention;

FIG. 2 shows a view of a headrest entertainment system positioned on a seat in a vehicle, according to an embodiment of the present invention; and

FIG. 3 shows multiple headrest entertainment systems interconnected in a vehicle, according to an embodiment of the present invention.

### DETAILED DESCRIPTION OF EXEMPLARY EMBODIMENTS

Exemplary embodiments of the present invention now will be described more fully hereinafter with reference to the accompanying drawings. This invention may, however, be embodied in many different forms and should not be construed as limited to the embodiments set forth herein.

A vehicle seat entertainment system incorporating a databus may include a number of entertainment systems 100 located in multiple seats of a vehicle, such as, for example, in headrests or seat bodies of an automobile, minivan or sport utility vehicle (SUV). Each entertainment system 100 can include a media unit 120 coupled to a housing 110 positioned in the headrest or seat body. The media unit 120 is connected to a databus for receipt and transmission of multiple audio and video signals.

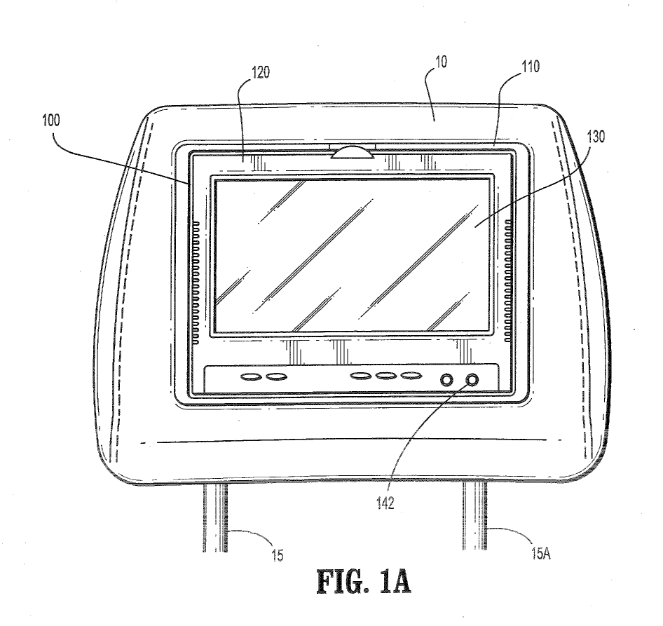

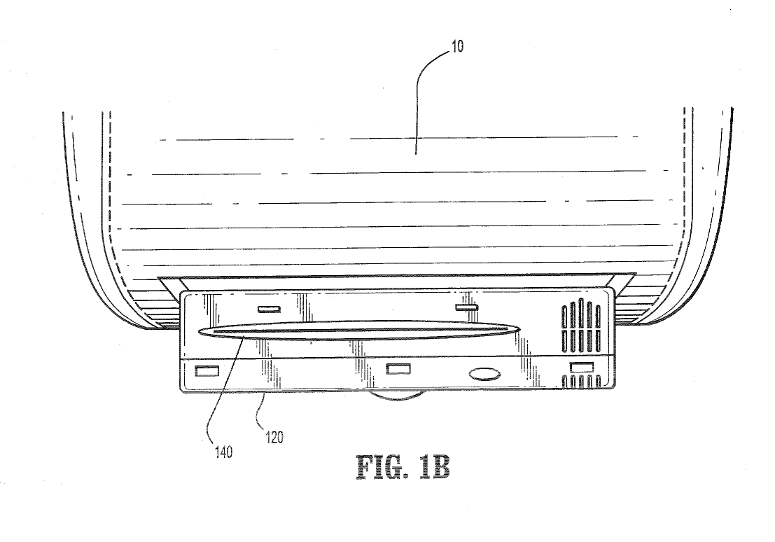

Referring to FIGS. 1A-1B, a headrest 10 includes an entertainment system 100 mounted therein. The entertainment system 100 includes a housing 110 and a media unit 120, which is coupled to the housing 110. The media unit 120 includes a display 130 having a screen for displaying video. The screen is preferably an LCD type display, but may be another type of display, such as, for example, a plasma display, an organic LED or electro-luminescent display.

In an embodiment, an LCD simultaneously displays different content in right and left viewing directions by directionally controlling the viewing angle of the LCD. In other words, one passenger can see a program from a first media source from a right side of the display, while another can see a program from a second media source from the left side of the display. The simultaneous display of different content on the display (e.g., display 130), is accomplished by superimposing a parallax barrier on a thin film transistor (TFT) LCD to enable light from a backlight to separate into right and left directions.

Video is supplied from a media source, for example, a DVD player 140 provided behind the display 130. The media source may also be, for example, a CD-ROM player, a video game player, a videocassette player, a television tuner, a radio tuner, a wireless receiver, an MP3 player, a digital video recorder (DVR), a device for playing media supplied from a portable storage device (e.g., a portable hard drive(s), memory cards, flash memory sticks, key drives, thumb drives), and/or a device for playing media supplied from a portable audio or video player, such as, for example, and IPOD®. The media unit 120 may include a memory device, for example, a DVR, which receives and stores video programming, and hardware for playing such programming. Alternatively, the display 130 can be electrically connected to an auxiliary media source through auxiliary port 142.

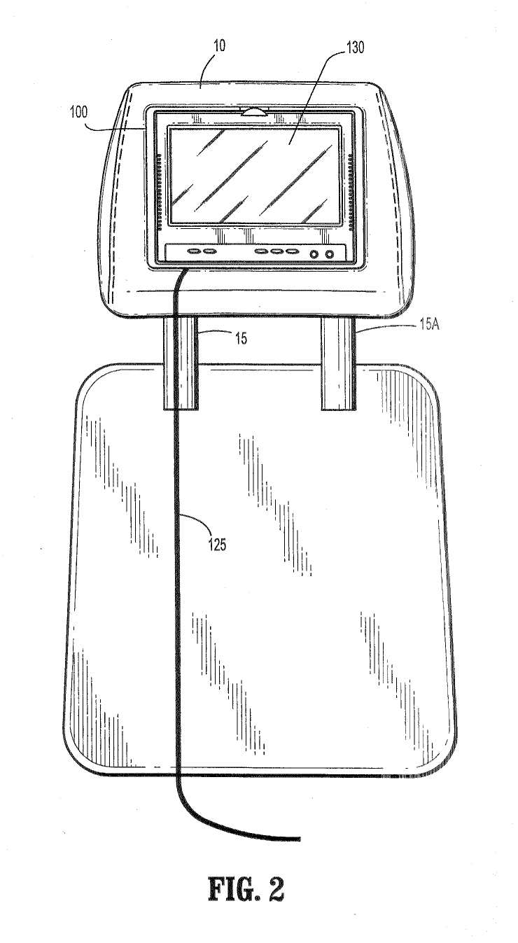

In addition, a headrest entertainment system 100 includes a single connection to a databus for transmission (i.e., input and output) of audio and video signals from a single source or multiple sources. Referring to FIG. 2, as an alternative to bulky multi-wire cables, a single databus 125 capable of high bandwidth signal communication, extends from the headrest entertainment system 100. The databus can be implemented in the form of an optical fiber or copper wire. The databus 125 carries information such as, for example, video and left and right audio outputs from multiple media sources connected to the databus.

A transmit circuit disposed at the distal end of the databus 125, and a receive circuit disposed proximal to the display, process the audio/video signals for proper transmission or reception of the signals to facilitate play of the audio/video program at the display.

In an embodiment wherein optical fiber is used as the databus 125, the transmit and receive circuits perform an optical communication protocol, including electrical to optical conversions, to effect signal communication. An example of an optical communication protocol is the Media Oriented Systems Transport (MOST) protocol.

An optical communication protocol, such as MOST, enables efficient transport of streaming multimedia information. Devices can communicate with each other using a high-speed connection over, for example, plastic optical fiber (POF). For example, a media source, such as a DVD player, can send audio and video around a network for simultaneous playback at several locations (e.g., multiple headrests) in a vehicle. Dynamic equalization and active noise cancellation on all audio signals flowing around the vehicle is possible because digital data is available to all device son a network. The optical fiber medium, such as, for example, POF, provides low infrastructure costs while making data impervious to electromagnetic disturbances.

An optical protocol, such as the MOST protocol, defines software interfaces to enable applications running on different devices to communicate and exchange information, and defines a transport mechanism that sets up a link for streaming data between devices. The protocol also defines the hardware interface needed to communicate over optical fiber.

In an embodiment where copper wire is used as the databus 125, the transmit and receive circuits perform the necessary multiplexing and data conversion known to one of ordinary skill in the art to effect communication of the programs.

The media sources connected to the databus can be positioned remote from the headrest entertainment system 100, such as in another part of the vehicle (e.g., under a seat, overhead, in another headrest). As stated above, a media source may be, for example, a DVD player, a CD-ROM player, a video game player, a videocassette player, a television tuner, a radio tuner, a wireless receiver, an MP3 player, a digital player, recorder (DVR), a device for playing media supplied from a portable storage device (e.g., a portable hard drive, memory cards, flash memory sticks, key drives, thumb drives), and/or a device for playing media supplied from a portable audio or video player, such as, for example, an IPOD®.

Referring to FIGS. 1A-1B, a media source may also be part of a media unit 120 positioned in the headrest 10. In such a case, the media source, for example, DVD player 140, supplies programming to the display 130 and is connected to the databus to supply programming to other displays or headrest entertainment systems positioned elsewhere in the vehicle.

Audio signals output from the media sources may be sent to and from headrest system 100, to the vehicle sound system and to wireless transmitters via the databus. Wireless transmitters, using, for example, radio frequency (RF), infrared (IR), BLUETOOTH, or 802.11 techniques, can transmit audio to, for example, receivers connected to a vehicle radio, wireless headphones or a display having a speaker(s).

In addition to the databus 125, wires for ground and power (connected to, for example, a vehicle power supply) are connected to the headrest entertainment system 100. Further, as an alternative to the single databus carrying audio and video, multiple buses, such as a video and an audio bus, may be used.

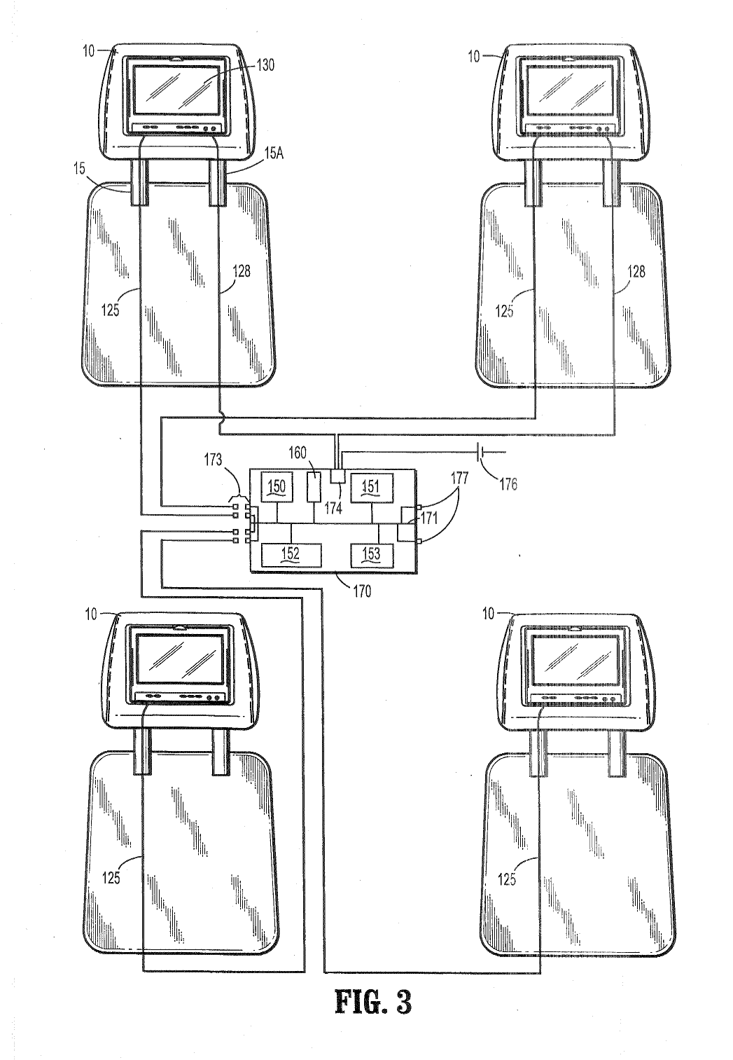

The databus line 125 (e.g., optical fiber or copper wire) is passed through a headrest support 15 routing the databus line 125 from the headrest entertainment system 100 to elsewhere in the vehicle. Upon routing to, for example, the bottom of a seat to which the headrest entertainment system 100 is mounted, multiple audio and video sources can be connected to databus line 125. The connection of the media sources to databus line 125 may be direct or indirect, such as through a wire harness or centralized system 170 (see FIG. 3). Connections may be supplied by any appropriate connectors capable of carrying high bandwidth, such as, for example, via universal serial bus (USB) type connections 173.

Referring to FIG. 3, headrest entertainment systems 100 in multiple headrests of a vehicle (e.g., in multiple rows of seating) can be linked via databus lines 125 connected to a centralized system 170. As shown in FIG. 3, multiple media sources, for example, a DVD player 150, a video game player 151, DVR 152 and memory card reader 153 are connected to a main databus 171 line, which in turn is connected to each of the lines 125 through, for example USB connections 173. Like the databus line 125, the main databus line 171 is a single connection for transmission and receipt (i.e., input and output) of multiple audio and video signals, and uses, for example, optical or copper wire protocols capable of carrying high bandwidth. Like the databus line 125, the main databus line 171 carries information, such as video and left and right audio outputs, from multiple media sources connected thereto.

In addition, content from a media source in a headrest system 100, for example, DVD player 140, can be transferred to any of the other headrest systems 100, or vice versa, via databus lines 125 and the main databus line 171.

As a result of the arrangement shown in FIG. 3, video and audio signals from multiple media sources (e.g., media sources 140, 150, 151, 152 and 153) are freely exchanged between multiple entertainment systems 100 within a vehicle. Therefore, the same or different programs can be simultaneously viewed on each of the entertainment systems 100.

In an alternative embodiment, the databus lines 125 are eliminated and exchange of video and audio information is performed by a wireless protocol (e.g., BLUETOOTH, or 802.11) capable of carrying high bandwidth video and audio information between multiple headrest entertainment systems 100. In other words, the wireless protocol functions as a wireless databus.

For example, each of the media sources 150-153 is connected to a wireless transmitter(s) 160 via the databus line 171. The wireless transmitter 160 transmits a broadcast stream of multiplexed audio and video signals from each of the media sources 150-153. Each of the headrest systems 100 is capable of receiving the broadcast stream. In addition, each of the headrest systems 100 may include a transmitter to send out wireless audio and video from a media source, for example DVD player 140, to the other headrest entertainment systems in a vehicle.

Selection of a desired program can be made, for example, on a menu displayed on a screen 130 of a headrest entertainment system 100, by tuning a selector to a desired channel on which a program has been assigned, and/or any appropriate method for media source/program selection known to one of ordinary skill in the art.

In an embodiment of the present invention, a centralized power relay 174 located in the centralized system 170 supplies power to each of the headrest entertainment systems via respective power lines 128 connected to the power relay 174. The power relay 174 is connected to a main power supply 176, such as a vehicle power source.

Connections to the relay 174 and to a power supply of a vehicle and ground may be supplied via connectors/adaptors known to those of skill in the art. The power and ground wires can be run through the same headrest post 15 as or a different headrest post 15A from the databus line 125.

The centralized system 170 can include additional input/output ports 177, for example, analog and/or digital input/output ports connected to databus line 171. The input/output ports 177 are used for attaching auxiliary media source(s) to the centralized system 170 for distribution of audio/video media from the auxiliary media source(s) to the entertainment systems 100 via the databus and/or for attaching receiving device(s) to the centralized system 170 for receiving audio and/or video data from the media sources 140 and 150-153.

Although exemplary embodiments of the present invention have been described hereinabove, it should be understood that the present invention is not limited to these embodiments, but may be modified by those skilled in the art without departing from the spirit and scope of the present invention, as defined in the appended claims.

What is claimed is:

1. A media system for a vehicle, comprising:
a media unit including a display mounted to a seat in the vehicle; and
a first databus electrically connected to a plurality of media sources, wherein the media unit is electrically connected to the first databus for receiving media from the plurality of media sources.

2. The media system according to claim 1, wherein the plurality of media sources and the first databus are positioned remote from the seat.

3. The media system according to claim 2, wherein the media unit is electrically connected to the first databus via a second databus.

4. The media system according to claim 3, wherein the second databus runs from the media unit through the seat.

5. The media system according to claim 4, wherein the first and second databus comprise optical fiber.

6. The media system according to claim 4, wherein the first and second databuses comprise copper wire.

7. The media system according to claim 3, wherein the second databus is wireless.

8. The media system according to claim 3, wherein the media unit further includes a first media source and media from the first media source is provided to the first databus via the second databus.

9. The media system according to claim 8, further comprising another media unit including another display mounted to another seat in the vehicle, wherein the other media unit is electrically connected to the first databus for receiving media from the plurality of media sources and the first media source.

10. The media system according to claim 9, wherein the other media unit is electrically connected to the first databus via a third databus.

11. The media system according to claim 3, further comprising another media unit including another display mounted to another seat in the vehicle, wherein the other media unit is electrically connected to the first databus via a third databus for receiving media from the plurality of media sources.

12. The media system according to claim 2, wherein the plurality of media sources are connected to a wireless transmitter via the first databus, and the wireless transmitter transmits a broadcast stream of multiplexed audio and video signals from the plurality of media sources.

13. The media system according to claim 12, wherein the media unit receives the broadcast stream.

14. A media system for a vehicle, comprising:
a first media unit including a first display mounted to a first seat of the vehicle;
a first databus line running from the first media unit;
a second media unit including a second display mounted to a second seat of the vehicle;
a second databus line running from the second media unit; and
a plurality of media sources electrically connected to a third databus line, wherein the first and second databus lines are electrically connected to the third databus line.

15. The media system according to claim 14, wherein the first and second databus lines run through the first and second seats, respectively.

16. The media system according to claim 14, wherein the first, second and third databus lines comprise optical fiber.

17. The media system according to claim 14, wherein the first, second and third databus lines comprise copper wire.

18. The media system according to claim 14, wherein the first media unit further includes a first media source and media from the first media source is provided to the third databus line via the first databus line.

19. The media system according to claim 18, wherein the second media unit receives media from the plurality of media sources and the first media source via the second databus line.

20. The media system according to claim 14, wherein the first media unit receives media from the plurality of media sources via the first databus line.

21. A media system for a vehicle, comprising:
a media unit including a display mounted to a seat of the vehicle;
a databus line running from the media unit through the seat; and
a plurality of media sources electrically connected to the databus line.

22. The media system according to claim 21, wherein the databus line comprises copper wire.

23. The media system according to claim 21, wherein the databus line comprises optical fiber.

24. The media system according to claim 23, wherein a transmit circuit is disposed at a first end of the databus line, and a receive circuit is disposed at a second end of the databus line, wherein the transmit and receive circuits process at least one of audio or video signals.

25. The media system according to claim 24, wherein the transmit and receive circuits perform an optical communication protocol, including electrical to optical conversions.
